(19) United States
(12) Patent Application Publication
(10) Pub. No.: US 2026/0246370 A1
(43) Pub. Date: Aug. 20, 2026

(54) POWER PROTECTION CIRCUIT AND SURGE PROTECTION CIRCUIT THEREOF

(71) Applicant: LEOTEK CORPORATION, Taipei City (TW)

(72) Inventor: Kuang-Ke WEI, Taipei City (TW)

(21) Appl. No.: 19/086,196

(22) Filed: Mar. 21, 2025

(30) Foreign Application Priority Data
Feb. 20, 2025 (TW) 114106251

(51) Int. Cl. H02M 1/34; H02M 1/00; H02M 1/44

(52) U.S. Cl. CPC H02M 1/348; H02M 1/0009; H02M 1/44

(57) ABSTRACT

A power protection circuit includes a surge protection circuit and a filter and conversion circuit. The surge protection circuit receives a power source. The surge protection circuit includes an overvoltage protection unit, a surge current limiting unit and a control unit. The filter and conversion circuit is coupled to the surge protection circuit. The overvoltage protection unit is coupled to the power source, and the surge current limiting unit is coupled to the overvoltage protection unit. The control unit is electrically coupled to the overvoltage protection unit and is configured to detect whether the overvoltage protection unit has failed and transmit a status signal.

This application claims the benefit of Taiwan application Serial No. 114106251, filed February 20, 2025, the subject matter of which is incorporated herein by reference.

### BACKGROUND OF THE INVENTION

### Field of the Invention

The invention relates in general to a circuit structure, and more particularly to a power protection circuit and a surge protection circuit thereof.

### Description of the Related Art

Surge, as the name suggests, is a transient overvoltage that exceeds the normal operating voltage. In fact, a surge is a violent pulse that occurs in just a few millionths of a second. Products containing surge protection devices (SPDs) can effectively absorb the sudden huge energy to protect the load device from damage.

A surge protection element is an electronic device that provides safety protection for various electronic equipment, instruments, and communication lines. When a surge current or voltage suddenly occurs in an electrical circuit or communication line due to external interference, the surge protection element can conduct and shunt the current in a very short time, thereby preventing the surge from damaging other electronic equipment in the circuit.

In addition, with the continuous advancement of LED lighting technology, networked communication technology can be used to achieve remote centralized control and management of lighting equipment. The remote functions include automatic brightness adjustment, remote lighting control, active fault alarm, line inspection, etc., which greatly improves the level of equipment management and saves maintenance costs. Therefore, how to use remote monitoring to understand the status of lamps and reduce maintenance costs is a topic that the industry is currently addressing urgently.

### SUMMARY OF THE INVENTION

The present invention relates to a power protection circuit and a surge protection circuit thereof, which are used to prevent surges from damaging electronic equipment.

According to one aspect of the present invention, a power protection circuit is provided, comprising a surge protection circuit and a filter and conversion circuit. The surge protection circuit is arranged for receiving a power source having a first voltage terminal and a second voltage terminal. The surge protection circuit comprises an overvoltage protection unit, a surge current limiting unit and a control unit. The filter and conversion circuit is coupled to the surge protection circuit. The overvoltage protection unit is coupled to the power source, the surge current limiting unit is coupled to the overvoltage protection unit, and the control unit is electrically coupled to the overvoltage protection unit for detecting whether the overvoltage protection unit has failed and transmitting a status signal.

According to another aspect of the present invention, a surge protection circuit is provided for receiving a power source. The surge protection circuit includes an overvoltage protection unit, a surge current limiting unit and a control unit. The overvoltage protection unit is coupled to the power source, the surge current limiting unit is coupled to the overvoltage protection unit, and the control unit is electrically coupled to the overvoltage protection unit for detecting whether the overvoltage protection unit has failed and transmitting a status signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a power protection circuit according to an embodiment of the present invention.

FIG. 2 is a block diagram of a power protection circuit according to another embodiment of the present invention.

FIG. 3 is a block diagram of a power protection circuit according to another embodiment of the present invention.

### DETAILED DESCRIPTION OF THE INVENTION

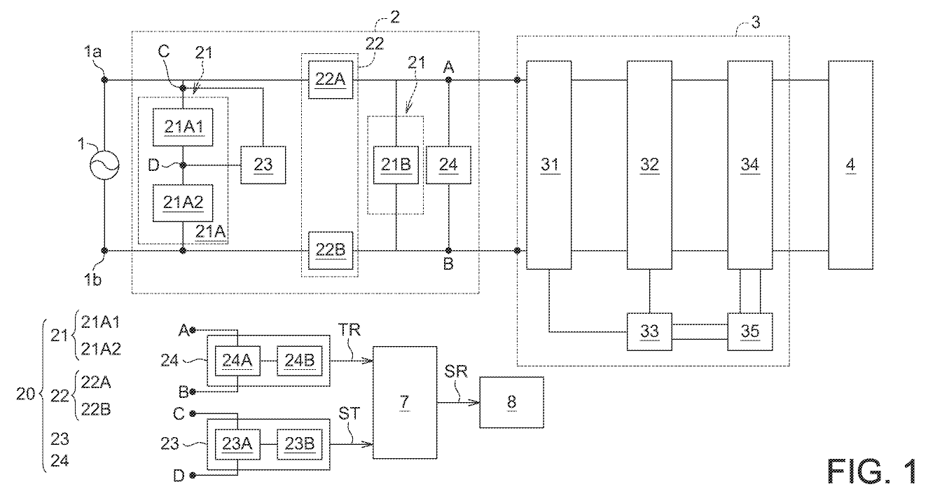

Referring to FIG. 1, a block diagram of a power protection circuit according to an embodiment of the present invention is illustrated. The power protection circuit is, for example, a power supply, which includes a surge protection circuit 2 and a filter and conversion circuit 3. The surge protection circuit 2 is configured to receive a power source 1 (such as Mains electricity), and the filter and conversion circuit 3 is configured to filter out noise and convert alternating current (AC) power (such as 110V) into direct current (DC) power to provide a working voltage required by a load device 4. The load device 4 is, for example, a lamp or an electronic component related to lamp control. The surge protection circuit 2 is disposed between the power source 1 and the filter and conversion circuit 3. An input terminal of the filter and conversion circuit 3 is coupled to an output terminal of the surge protection circuit 2, and an output terminal of the filter and conversion circuit 3 is coupled to the load device 4 to prevent the surge from damaging the load device 4.

The filter and conversion circuit 3 includes a noise processing unit 31, an isolation unit 32, a signal control unit 33, an output unit 34 and a feedback control unit 35. The noise processing unit 31 may be an input-stage filter circuit, the output unit 34 may be an output-stage filter circuit, and the isolation unit 32 may be a transformer peripheral circuit. The noise processing unit 31, the isolation unit 32 and the signal control unit 33 are configured to rectify the working current and convert the working voltage into different voltage values. The signal control unit 33 determines the on/off state of the isolation unit 32 based on the output of the feedback control unit 35. The output unit 34 can output the working voltage required by the load device 4. The control chip (not shown) in the feedback control unit 35 can control the power output to the signal control unit 33 according to feedback calculation of the power difference.

The power source 1 has a first voltage terminal 1a and a second voltage terminal 1b. The surge protection circuit 2 includes an overvoltage protection unit 21, a surge current limiting unit 22, a first control unit 23 and a second control unit 24. The overvoltage protection unit 21 may include a first overvoltage protection element 21A and a second overvoltage protection element 21B. The surge current limiting unit 22 may include a first current limiting element 22A and a second current limiting element 22B.

In addition, the filter and conversion circuit 3 may include two input terminals electrically coupled to the A and B terminals of the second control unit 24 respectively. The first overvoltage protection element 21A of the overvoltage protection unit 21 is coupled to the first voltage terminal 1a and the second voltage terminal 1b respectively, and first and second ends of the second overvoltage protection element 21B are electrically coupled to the A and B terminals of the second control unit 24 respectively. Two ends of the first current limiting element 22A of the surge current limiting unit 22 are respectively coupled to one end of the first overvoltage protection element 21A and the first end of the second overvoltage protection element 21B, while two ends of the second current limiting element 22B are respectively coupled to the other end of the first overvoltage protection element 21A and the second end of the second overvoltage protection element 21B.

As shown in the lower left corner of FIG. 1, the lighting control system may include a wireless communication module 7 and a remote server 8. The wireless communication module 7 is coupled to the first control unit 23 and the second control unit 24 to receive a status signal ST and/or a trigger signal TR and transmit a report signal SR to the remote server 8.

The wireless communication module 7 may be a communication module such as Wi-Fi, NB-IOT (Narrowband Internet of Things), Zigbee, LoRa (long range) or Wi-SUN (Wireless Smart Utility Network). In one embodiment, a gateway of the Wi-Fi communication module is coupled to the remote server 8 via a wireless Wi-Fi network. The remote server 8 sends light on/off control, brightness control or other control commands to the gateway according to the specified data format. After receiving the data, the gateway parses it according to the specified data format. After parsing, the address of the controlled lamp is obtained and the command is actually issued. The commands include on/off commands or light intensity adjustments.

Referring to FIG. 1, the first overvoltage protection element 21A is coupled to the first voltage terminal 1a and the second voltage terminal 1b to provide a first level of overvoltage protection. The second overvoltage protection element 21B is configured to provide a second level of overvoltage protection. The first overvoltage protection element 21A and the second overvoltage protection element 21B may include the same or different surge protection elements.

In addition, the first overvoltage protection element 21A further includes a metal oxide varistor 21A1 and a thermal fuse 21A2. The first end of the metal oxide varistor 21A1 is coupled to the first voltage terminal 1a, and the second end of the metal oxide varistor 21A1 is coupled to the first end of the thermal fuse 21A2. The second end of the thermal fuse 21A2 is coupled to the second voltage terminal 1b. When the metal oxide varistor 21A1 is abnormal, such as overheating, the metal oxide varistor 21A1 fails thermally and generates a short-circuit current. The short-circuit current passes through the thermal fuse 21A2 and disconnects the thermal fuse 21A2. The metal oxide varistor 21A1 is mainly composed of a stacked lattice element, and usually breaks down due to a temperature rise caused by an overly high operating voltage/operating current. In order to avoid thermal failure of the metal oxide varistor 21A1, the present embodiment integrates the overvoltage protection unit 21 into the power protection circuit to increase the heat dissipation space of the metal oxide varistor 21A1, weaken the cumulative effect of the temperature rise, and thereby effectively extend the working period of the metal oxide varistor 21A1. In addition, although not shown in the figure, the second overvoltage protection element 21B may also include a metal oxide varistor and a thermal fuse, and its function is the same as that of the first overvoltage protection element 21A, which is not described in detail here.

In one embodiment, the first current limiting element 22A and the second current limiting element 22B are, for example, thermistors. A thermistor is a current limiter with a negative temperature coefficient and is used to reduce transient current. The thermistor is, for example, made of a metal oxide ceramic material and has a very high resistance at room temperature and can be used to suppress transient surge current.

The first control unit 23 in the present embodiment further includes a status collection unit 23A and a status trigger unit 23B. The two ends of the status collection unit 23A are coupled to the C and D ends of the metal oxide varistor 21A1. The status trigger unit 23B is coupled to the status collection unit 23A. The first control unit 23 is configured to detect a status signal ST when the metal oxide varistor 21A1 is short-circuited and the thermal fuse 21A2 is disconnected, so as to determine that the first overvoltage protection element 21A has failed.

In addition, the second control unit 24 includes a signal collection unit 24A and a power failure trigger unit 24B. The power failure trigger unit 24B is coupled to the signal collection unit 24A. The second control unit 24 is configured to detect a trigger signal TR caused by a power failure of the power source 1. When the external power source (e.g., 110V AC power) is interrupted or abnormal, the second control unit 24 transmits a trigger signal TR to the wireless communication module 7, and the wireless communication module 7 transmits a report signal SR to the remote server 8. The remote server 8 can receive the report signal SR to notify the maintenance manufacturer to send personnel to repair the power failure.

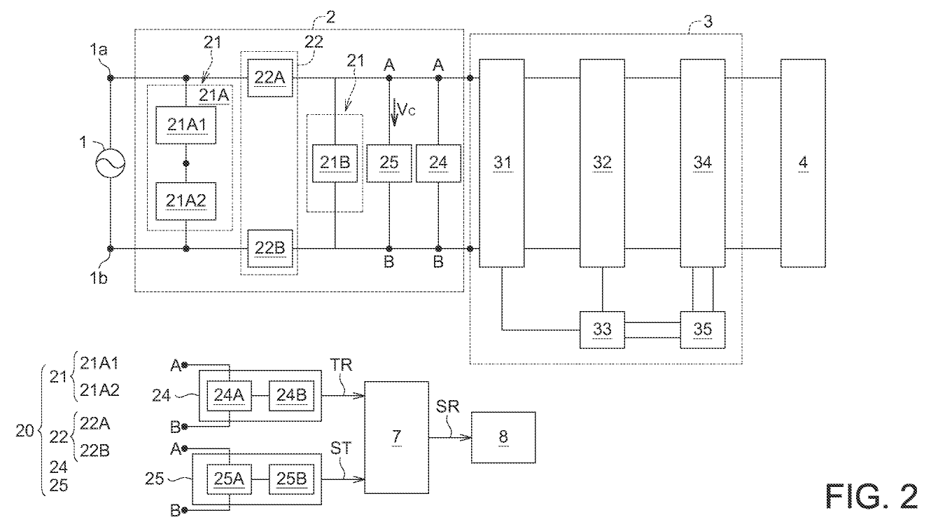

Referring to FIG. 2, a block diagram of a power protection circuit according to another embodiment of the present invention is illustrated. The power protection circuit is, for example, a power supply, which includes a surge protection circuit 2 and a filter and conversion circuit 3. The filter and conversion circuit 3 is coupled to the surge protection circuit 2 to prevent surges from damaging the load device 4. The filter and conversion circuit 3 includes a noise processing unit 31, an isolation unit 32, a signal control unit 33, an output unit 34 and a feedback control unit 35. For the description of the noise processing unit 31, the isolation unit 32, the signal control unit 33, the output unit 34 and the feedback control unit 35, please refer to the above-mentioned embodiment, which is not described in detail here.

The surge protection circuit 2 is configured to receive a power source 1. The power source 1 has a first voltage terminal 1a and a second voltage terminal 1b. The surge protection circuit 2 includes an overvoltage protection unit 21, a surge current limiting unit 22 and a first control unit 25. In addition, the surge protection circuit 2 may further include a second control unit 24. Regarding the second control unit 24, please refer to the above embodiment and is not described in detail here. In addition, the second control unit 24 and the first control unit 25 may be two independent control devices, or the second control unit 24 and the first control unit 25 may be combined into a single control device to perform the power failure reporting function.

In addition, the filter and conversion circuit 3 includes two input terminals electrically coupled to the A and B ends of the control unit 25 respectively. The first overvoltage protection element 21A of the overvoltage protection unit 21 is coupled to the first voltage terminal 1a and the second voltage terminal 1b respectively, and the first end and the second end of the second overvoltage protection element 21B are electrically coupled to the A and B ends of the control unit 25 respectively. Two ends of the first current limiting element 22A of the surge current limiting unit 22 are respectively coupled to one end of the first overvoltage protection element 21A and the first end of the second overvoltage protection element 21B, while two ends of the second current limiting element 22B are respectively coupled to the other end of the first overvoltage protection element 21A and the second end of the second overvoltage protection element 21B. The control unit 25 is used to detect whether the overvoltage protection unit 21 has failed and transmit a status signal ST.

In addition, the first overvoltage protection element 21A includes a metal oxide varistor 21A1 and a thermal fuse 21A2. The metal oxide varistor 21A1 has a first end and a second end. The first end is coupled to the first voltage terminal 1a, the second end is coupled to the first end of the thermal fuse 21A2, and the second end of the thermal fuse 21A2 is coupled to the second voltage terminal 1b.

The power protection circuit of this embodiment is different from that of the above-mentioned embodiment in that: the first control unit 25 of this embodiment includes a voltage detection circuit 25A and a status trigger unit 25B. The voltage detection circuit 25A is coupled to the first end and the second end of the second overvoltage protection element 21B. The status trigger unit 25B is coupled to the voltage detection circuit 25A. The first control unit 25 is configured to detect a status signal ST indicating that a clamping voltage Vc of the metal oxide varistor 21A1 has changed. The status trigger unit 25B is configured to transmit the status signal ST to the wireless communication module 7 to notify the overvoltage protection unit 21 of failure.

The voltage detection circuit 25A can convert the AC current of the power source into a DC voltage through an AC/DC conversion method. The DC voltage reflects the actual voltage of the AC power source and compares the DC voltage with a first clamping voltage and a second clamping voltage that is smaller than the first clamping voltage. When the DC voltage is greater than the first clamping voltage or less than the second clamping voltage, a status change signal is generated. That is, when the metal oxide varistor 21A1 operates normally, the clamping voltage Vc is a fixed value. However, when the metal oxide varistor 21A1 operates abnormally, the clamping voltage Vc increases or decreases. When the clamping voltage Vc is abnormal, it indicates that the function of the metal oxide varistor 21A1 may be damaged, so that the first control unit 25 can determine that the overvoltage protection unit 21 has failed.

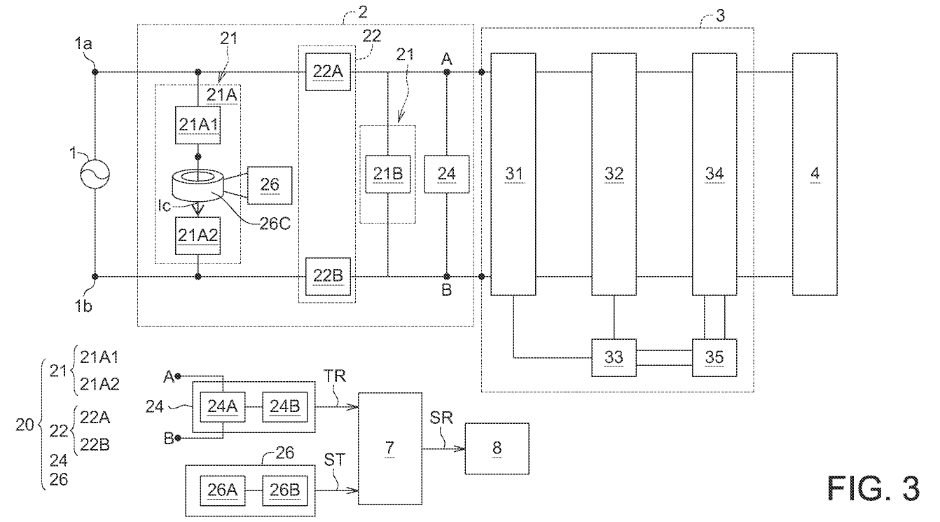

Referring to FIG. 3, a block diagram of a power protection circuit according to another embodiment of the present invention is provided. The power protection circuit is, for example, a power supply, which includes a surge protection circuit 2 and a filter and conversion circuit 3. The filter and conversion circuit 3 is coupled to the surge protection circuit 2 to prevent surges from damaging the load device 4. The filter and conversion circuit 3 includes a noise processing unit 31, an isolation unit 32, a signal control unit 33, an output unit 34 and a feedback control unit 35. For the description of the noise processing unit 31, the isolation unit 32, the signal control unit 33, the output unit 34 and the feedback control unit 35, please refer to the above-mentioned embodiment, which is not described in detail here.

The surge protection circuit 2 is configured to receive a power source 1. The power source 1 has a first voltage terminal 1a and a second voltage terminal 1b. The surge protection circuit 2 includes an overvoltage protection unit 21, a surge current limiting unit 22 and a control unit 26. In addition, the surge protection circuit 2 may further include a second control unit 24. Regarding the second control unit 24, please refer to the above embodiment and is not described in detail here. The overvoltage protection unit 21 may include a first overvoltage protection element 21A and a second overvoltage protection element 21B. The surge current limiting unit 22 may include a first current limiting element 22A and a second current limiting element 22B.

In addition, two ends of the first overvoltage protection element 21A of the overvoltage protection unit 21 are respectively coupled to the first voltage terminal 1a and the second voltage terminal 1b, while the first end and the second end of the second overvoltage protection element 21B are respectively coupled to two input ends of the filter and conversion circuit 3. Two ends of the first current limiting element 22A of the surge current limiting unit 22 are respectively coupled to the first voltage terminal 1a and the first end of the second overvoltage protection element 21B, and two ends of the second current limiting element 22B are respectively coupled to the second voltage terminal 1b and the second end of the second overvoltage protection element 21B. The first control unit 26 is configured to detect whether the overvoltage protection unit 21 has failed and transmit a status signal ST.

Referring to FIG. 3, the first overvoltage protection element 21A is coupled to the first voltage terminal 1a and the second voltage terminal 1b to provide a first level of overvoltage protection. The second overvoltage protection element 21B is coupled to two input ends of the filter and conversion circuit 3 to provide a second level of overvoltage protection. The first overvoltage protection element 21A and the second overvoltage protection element 21B may include the same or different surge protection elements.

In addition, the first overvoltage protection element 21A includes a metal oxide varistor 21A1 and a thermal fuse 21A2. The first end of the metal oxide varistor 21A1 is coupled to the first voltage terminal 1a, the second end is coupled to the first end of the thermal fuse 21A2, and the second end of the thermal fuse 21A2 is coupled to the second voltage terminal 1b.

The difference between the power protection circuit of this embodiment and the above-mentioned embodiment is that the first control unit 26 of this embodiment includes a current detection circuit 26A and a status trigger unit 26B. The current detection circuit 26A is disposed between the second end of the metal oxide varistor 21A1 and the first end of the thermal fuse 21A2. The status trigger unit 26B is coupled to the current detection circuit 26A. The first control unit 26 is configured to detect a status signal ST of a short-circuit current Ic passing through the metal oxide varistor 21A1. The status trigger unit 26B is configured to transmit the status signal ST to the wireless communication module 7 to notify the first overvoltage protection element 21A of failure.

In one embodiment, the current detection circuit 26A includes a Hall current sensor for detecting the short-circuit current Ic passing through the Hall magnet 26C, for example, by measuring the magnitude of the magnetic field generated in the Hall magnet 26C according to the flowing current so as to measure the current value of the short-circuit current Ic. In another embodiment, the current detection circuit 26A may include a magneto-impedance current sensor for detecting the magnitude of magneto-impedance to measure the current value of the short-circuit current Ic. Therefore, when the overvoltage protection unit 21 fails or is overloaded, causing the current to exceed the normal range, the first control unit 26 can transmit a status signal ST to the wireless communication module 7, and the remote server 8 can receive a report signal SR to notify the maintenance manufacturer to send personnel for repair.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power protection circuit, comprising:
a surge protection circuit for receiving a power source, the surge protection circuit comprising an overvoltage protection unit, a surge current limiting unit and a control unit; and
a filter and conversion circuit coupled to the surge protection circuit;
wherein the overvoltage protection unit is coupled to the power source, the surge current limiting unit is coupled to the overvoltage protection unit, and the control unit is electrically coupled to the overvoltage protection unit to detect whether the overvoltage protection unit has failed and transmit a status signal.

2. The power protection circuit of claim 1, wherein the overvoltage protection unit includes a first overvoltage protection element and a second overvoltage protection element, the first overvoltage protection element is coupled to two terminals of the power source, the second overvoltage protection element is coupled to two input ends of the filter and conversion circuit, the first overvoltage protection element comprises a metal oxide varistor and a thermal fuse, and the metal oxide varistor is coupled to the thermal fuse.

3. The power protection circuit of claim 2, wherein the control unit includes a first control unit, the first control unit comprises a status collection unit and a status trigger unit, the status collection unit is coupled to two ends of the metal oxide varistor, the status trigger unit is coupled to the status collection unit, and the first control unit is configured to detect the status signal indicating that the metal oxide varistor is short-circuited and causes the thermal fuse to be disconnected.

4. The power protection circuit of claim 3, wherein the control unit further includes a second control unit, the second control unit is electrically coupled to two ends of the second overvoltage protection element, the second control unit includes a signal collection unit and a power failure trigger unit, the signal collection unit is coupled to the power failure trigger unit, and the second control unit is configured to detect a trigger signal caused by the power failure.

5. The power protection circuit of claim 4 further comprises a wireless communication module, wherein the wireless communication module is coupled to the first control unit and the second control unit for transmitting the status signal or the trigger signal to a remote server.

6. The power protection circuit of claim 2, wherein the control unit comprises a first control unit, the first control unit comprises a voltage detection circuit and a status trigger unit, the first control unit is coupled to two ends of the second overvoltage protection element, the voltage detection circuit is coupled to the status trigger unit, and the first control unit is configured to detect the status signal indicating a change in a clamping voltage of the metal oxide varistor.

7. The power protection circuit of claim 6, wherein the control unit further includes a second control unit, the second control unit is electrically coupled to two ends of the second overvoltage protection element, the second control unit includes a signal collection unit and a power failure trigger unit, the signal collection unit is coupled to the power failure trigger unit, and the second control unit is configured to detect a trigger signal caused by the power failure.

8. The power protection circuit of claim 7, wherein the first control unit and the second control unit are two independent control devices, or the second control unit and the first control unit are combined into a single control device.

9. The power protection circuit of claim 7, further comprising a wireless communication module, the wireless communication module is coupled to the first control unit and the second control unit for transmitting the status signal or the trigger signal to a remote server.

10. The power protection circuit of claim 2, wherein the control unit includes a first control unit, the first control unit includes a current detection circuit and a status trigger unit, the current detection circuit is disposed between the metal oxide varistor and the thermal fuse, the current detection circuit is coupled to the status trigger unit, and the current detection circuit is configured to detect the status signal indicating a change in a short-circuit current passing through the metal oxide varistor.

11. The power protection circuit of claim 10, wherein the control unit further includes a second control unit, the second control unit is electrically coupled to two ends of the second overvoltage protection element, the second control unit includes a signal collection unit and a power failure trigger unit, the signal collection unit is coupled to the power failure trigger unit, and the second control unit is configured to detect a trigger signal caused by the power failure.

12. The power protection circuit of claim 11, further comprising a wireless communication module, wherein the wireless communication module is coupled to the first control unit and the second control unit for transmitting the status signal or the trigger signal to a remote server.

13. The power protection circuit of claim 10, wherein the current detection circuit comprises a Hall current sensor.

14. The power protection circuit of claim 10, wherein the current detection circuit comprises a magneto-impedance current sensor.

15. A surge protection circuit for receiving a power source, the surge protection circuit comprising:
an overvoltage protection unit;
a surge current limiting unit; and
a control unit,
wherein the overvoltage protection unit is coupled to the power source, the surge current limiting unit is coupled to the overvoltage protection unit, and the control unit is electrically coupled to the overvoltage protection unit to detect whether the overvoltage protection unit has failed and transmit a status signal.

16. The surge protection circuit of claim 15, wherein the overvoltage protection unit comprises a first overvoltage protection element and a second overvoltage protection element, the first overvoltage protection element is coupled to two terminals of the power source, the first overvoltage protection element comprises a metal oxide varistor and a thermal fuse, and the metal oxide varistor is coupled to the thermal fuse.

17. The surge protection circuit of claim 16, wherein the control unit includes a first control unit, the first control unit includes a status collection unit and a status trigger unit, the status collection unit is coupled to two ends of the metal oxide varistor, the status trigger unit is coupled to the status collection unit, and the first control unit is configured to detect the status signal indicating that the metal oxide varistor is short-circuited and causes the thermal fuse to be disconnected.

18. The surge protection circuit of claim 17, wherein the control unit further includes a second control unit, the second control unit is electrically coupled to two ends of the second overvoltage protection element, the second control unit comprises a signal collection unit and a power failure trigger unit, the signal collection unit is coupled to the power failure trigger unit, and the second control unit is configured to detect a trigger signal caused by the power failure.

19. The surge protection circuit of claim 16, wherein the control unit comprises a first control unit, the first control unit comprises a voltage detection circuit and a status trigger unit, the first control unit is coupled to two ends of the second overvoltage protection element, the voltage detection circuit is coupled to the status trigger unit, and the control unit is configured to detect the status signal indicating a change in a clamping voltage of the metal oxide varistor.

20. The surge protection circuit of claim 16, wherein the control unit comprises a first control unit, the first control unit comprises a current detection circuit and a status trigger unit, the current detection circuit is disposed between the metal oxide varistor and the thermal fuse, the current detection circuit is coupled to the status trigger unit, and the current detection circuit is configured to detect the status signal indicating a change in a short-circuit current passing through the metal oxide varistor.

21. The surge protection circuit of claim 19, wherein the control unit further comprises a second control unit, the second control unit is electrically coupled to two ends of the second overvoltage protection element, the second control unit comprises a signal collection unit and a power failure trigger unit, the signal collection unit is coupled to the power failure trigger unit, and the second control unit is configured to detect a trigger signal caused by the power failure.

22. The surge protection circuit of claim 20, wherein the control unit further comprises a second control unit, the second control unit is electrically coupled to two ends of the second overvoltage protection element, the second control unit comprises a signal collection unit and a power failure trigger unit, the signal collection unit is coupled to the power failure trigger unit, and the second control unit is configured to detect a trigger signal caused by the power failure.
* * * * *
